(19) United States
(12) Patent Application Publication
(10) Pub. No.: US 2015/0077554 A1
(43) Pub. Date: Mar. 19, 2015

(54) ADDRESSABLE MONITORING SYSTEM

(71) Applicant: YOMORE TECHNOLOGY CO., LTD., Kaohsiung City (TW)

(72) Inventor: Jao-Ching Lin, KAOHSIUNG CITY (TW)

(21) Appl. No.: 14/484,267

(22) Filed: Sep. 12, 2014

(30) Foreign Application Priority Data
Sep. 13, 2013 (TW) 102133259

(51) Int. Cl. H04N 7/18; H04N 19/44; G06K 9/62

(52) U.S. Cl. CPC H04N 7/183; G06K 9/6202; H04N 19/00533
USPC 348/143

(57) ABSTRACT

An addressable monitoring system includes at least one image module and a control module. Each image module of the at least one image module has an identification code and includes a lens unit, an encoder, and a first transceiver unit. The lens unit captures an image according to a control signal. The encoder modulates the identification code into the image to generate a modulation signal. The first transceiver unit transmits the modulation signal. The control module includes a signal generation unit, a second transceiver unit, a decoder, and a comparison unit. The signal generation unit generates the control signal. The second transceiver unit receives the modulation signal. The decoder decodes the modulation signal to generate a decoded image and the identification code. The comparison unit compares the decoded image with a reference image and determines whether the decoded image matches the reference image.

### BACKGROUND OF THE INVENTION

1. Field of the Invention

The present invention relates to an addressable monitoring system, and more particularly, to an addressable monitoring system that has an image comparison function and an image module corresponding to a specific identification code.

2. Description of the Prior Art

A door monitoring system provided by the prior art utilizes magnetism reed switches to execute monitoring operation. However, the magnetism reed switches have following disadvantages: first, the magnetism reed switches require to install different elements (such as an independent power line and a data line) separately, so installation of the magnetism reed switches are inconvenient; second, the magnetism reed switch is enabled through magnetic induction, so, locations of the magnetism reed switches first need to be calibrated when installing the magnetism reed switch, resulting in sensing ability being deteriorated due to deviation of the locations of the magnetism reed switches; third, when installing the magnetism reed switches, a number of power lines and data lines will be increased with increase of a number of sensors of the magnetism reed switches, resulting in the indoor decorations being destroyed due to drill holes caused by the power lines and the data lines; fourth, the prior art cannot monitor the magnetism reed switches through built-in identification codes, respectively; and fifth, doors or windows installed with the magnetism reed switches need to be airtight, thus making the indoor environment improper ventilated.

Therefore, magnetism reed switches provided by the prior art are not a good choice for a user.

### SUMMARY OF THE INVENTION

An embodiment of the present invention provides an addressable monitoring system. The addressable monitoring system includes at least one image module and a control module. Each image module of the at least one image module has an identification code, and includes a lens unit, an encoder and a first transceiver unit. The lens unit is used for capturing an image according to a control signal. The encoder is used for modulating the identification code into the image to generate a modulation signal. The first transceiver unit is used for transmitting the modulation signal. The control module includes a signal generation unit, a second transceiver unit, a decoder and a comparison unit. The signal generation unit is used for generating the control signal. The second transceiver unit is used for receiving the modulation signal. The decoder is used for decoding the modulation signal to generate a decoded image corresponding to the image and the identification code. The comparison unit is used for comparing the decoded image with a reference image, and determining whether the decoded image matches the reference image.

Another embodiment of the present invention provides an addressable monitoring system. The addressable monitoring system includes at least one image module and a control module. Each image module of the at least one image module has an identification code, and the image module includes a lens unit, a comparison unit and a first transceiver unit. The lens unit is for capturing an image according to a control signal. The comparison unit is used for comparing the image with a reference image, and determining whether the image matches the reference image. When the image does not match the reference image, the comparison unit generates and transmits an alarm signal. The first transceiver unit is used for transmitting the alarm signal and the identification code. The control module includes a signal generation unit, a second transceiver unit and a notification unit. The signal generation unit is used for generating the control signal. The second transceiver unit is used for receiving the alarm signal and the identification code. The notification unit is used for transmitting the alarm signal and the identification code to a portable device.

Another embodiment of the present invention provides an addressable monitoring system. The addressable monitoring system includes at least one image module. Each image module of the at least one image module has an identification code, and the image module includes a lens unit, a comparison unit and an alarm unit. The lens unit is used for capturing an image. The comparison unit is used for comparing the image with a reference image, and determining whether the image matches the reference image. When the image does not match the reference image, the comparison unit generates and transmits an alarm signal. The alarm unit is used for generating a combination of flicker light and special sound according to the alarm signal.

The present invention provides an addressable monitoring system. The addressable monitoring system utilizes each image module to capture an image including at least one monitored object, and then compares the image including at least one monitored object with a reference image to determine whether the at least one monitored object is unusual. Hence, compared with the prior art, the present invention includes the following advantages: first, since each image module has a corresponding identification code, the user can be quickly aware of which monitored object of the at least one monitored object is unusual; second, since each image module of the addressable monitoring system is coupled to the same power line, and unitizes the same power line to transmit a signal including an identification code of each image module of the addressable monitoring system, the present invention has simple arrangement and will not affect indoor decoration; third, the user can be aware of which monitored object of the at least one monitored object is unusual in real-time through the portable device; fourth, since each of the image modules of the addressable monitoring system is capable of monitoring one or multiple objects according to the user's requirement, the present invention is more flexible to be designed; and fifth, since the present invention determines whether a monitored object of the at least one monitored object is unusual through image comparison, the at least one monitored object does not need to be airtight to keep the indoor environment to be well ventilated.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an addressable monitoring system according to an embodiment of the present invention.

FIG. 2 is a diagram illustrating an image module and a control module.

FIG. 3 is a diagram illustrating an image captured by a lens unit.

FIG. 4 is a diagram illustrating an open state of a window.

FIG. 5 is a diagram illustrating an addressable monitoring system according to another embodiment of the present invention.

FIG. 6 is a diagram illustrating an addressable monitoring system according to yet another embodiment of the present invention.

### DETAILED DESCRIPTION

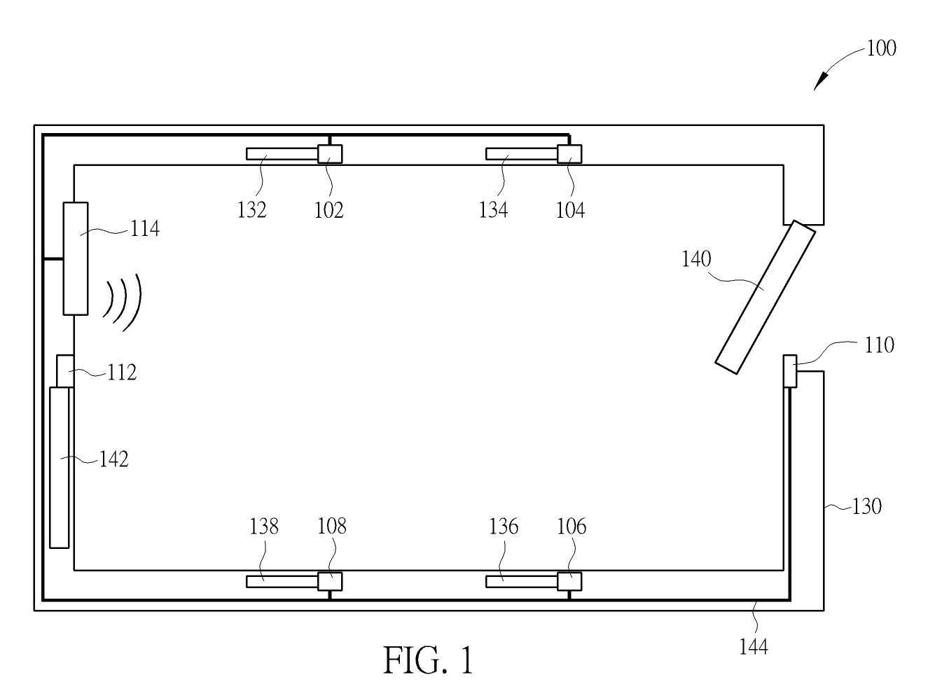

FIG. 1, which is a diagram illustrating an addressable monitoring system 100 according to an embodiment of the present invention. The addressable monitoring system 100 includes image modules 102-112 and a control module 114. Each image module of the image modules 102, 104, 106 and 108 are used to monitor windows 132, 134, 136 and 138 of a room 130, respectively. The image module 110 and 112 are used to monitor doors 140 and 142 of the room 130, respectively. Further, the image modules 102-112 and the control module 114 can be coupled to the same power line 144. However, the present invention is not limited to the image modules 102-112 and the control module 114 being coupled to the same power line 144. That is to say, the image modules 102-112 and the control module 114 can be coupled to different power lines. As shown in FIG. 1, each image module of the image modules 102-112 is used for monitoring a window or a door. However, the present invention is not limited to each image module of the image modules 102-112 being used for monitoring an object (such as a window or a door). That is, each image module of the image modules 102-112 can monitor more than one object. Moreover, the present invention does not limit relative positions of the image modules 102-112, the windows 132-138 and the doors 140 and 142 as shown in FIG. 1.

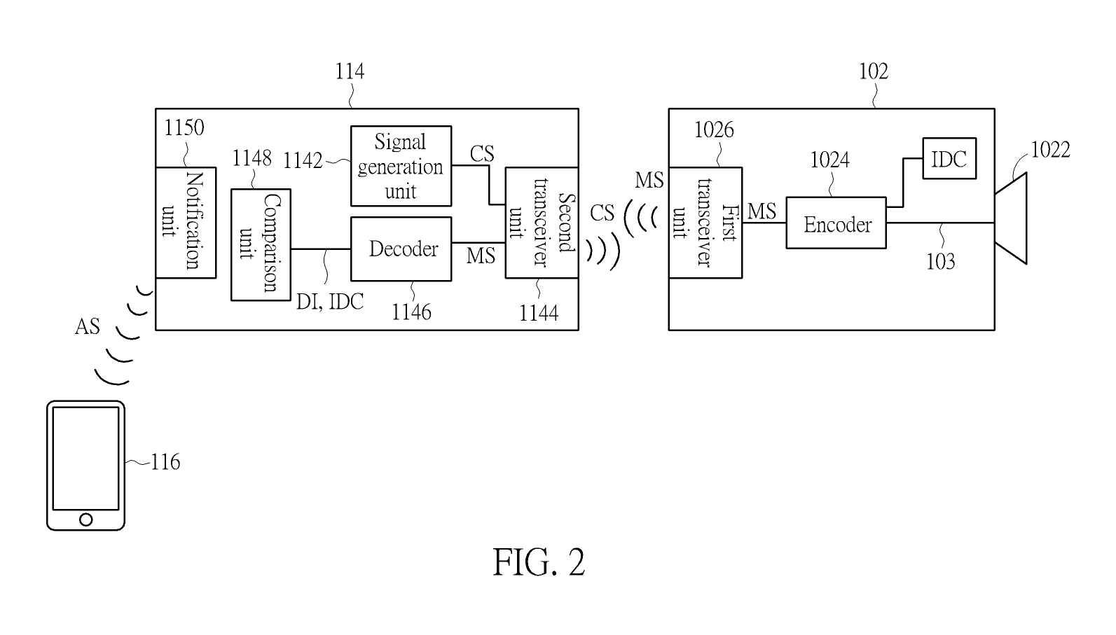

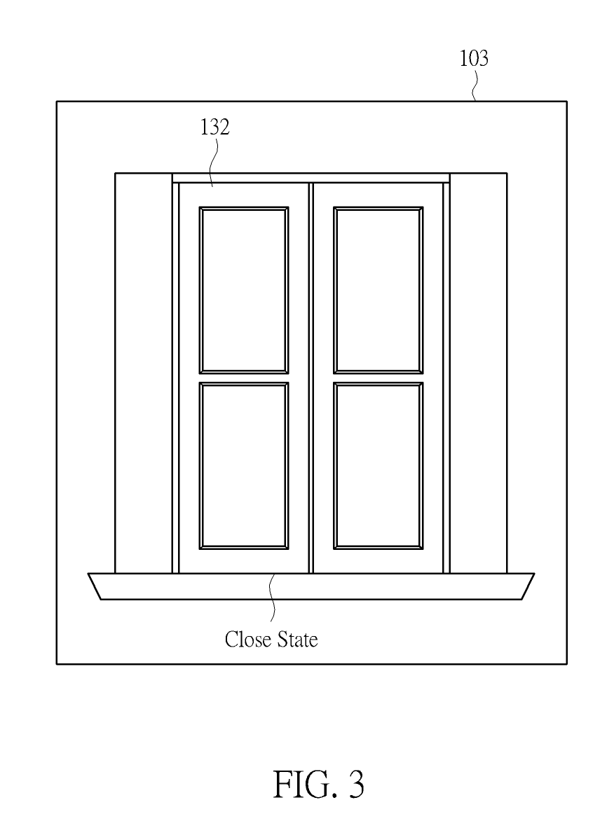

Please refer to FIG. 2 and FIG. 3. FIG. 2 is a diagram illustrating the image module 102 and the control module 114. FIG. 3 is a diagram illustrating an image 103 captured by a lens unit 1022. Because each image module of the image modules 104-112 are the same as the image module 102, and will be omitted for brevity. As shown in FIG. 2, the image module 102 has a specific identification code IDC and the image module 102 includes the lens unit 1022, an encoder 1024 and a first transceiver unit 1026. The identification code IDC is burned to the image module 102 before or after the image module 102 is shipped. After the identification code IDC is burned to the image module 102, a user can still update the identification code IDC of the image module 102 according to his requirement. Further, as shown in FIG. 2, the control module 114 includes a signal generation unit 1142, a second transceiver unit 1144, a decoder 1146, a comparison unit 1148, and a notification unit 1150.

As shown in FIG. 2, the lens unit 1022 is used for capturing the image 103 according to a control signal CS generated by the control module 114. As shown in FIG. 1, since the image module 102 is used for monitoring the window 132 of the room 130, the image 103 relates to a current state of the window 132. However, if the image module 102 monitors more than one object, the image 103 will include current states of multiple objects. The encoder 1024 is used for compressing the image 103 and modulate the identification code IDC into the image 103 to generate a modulation signal MS. The encoder 1024 can utilize a JPEG algorithm or an MPEG algorithm to compress the image 103. However, the present invention is not limited to the encoder using a JPEG algorithm or an MPEG algorithm to compress the image 103. That is, the encoder 1024 can use other existing techniques to compress the image 103. For example, the encoder can compress the image 103 through a hybrid video coding algorithm based on blocks (such as MPEG-X, H.26X), or utilizes a method of motion compensated prediction (MCP) and a transforming coding (such as discrete cosine transform (DCT)). The first transceiver unit 1026 is used for transmitting the modulation signal MS to the second transceiver unit 1144 of the control module 114. The first transceiver unit 1026 transmits the modulation signal MS to the second transceiver unit 1144 through a wireless local area network (WLAN), a Zigbee (IEE 802.15.4) standard, a Bluetooth, a wireless wide area network (WLAN), a global system for mobile communications (GSM), a general packet radio service (GPRS), a third generation (3G) technique, a wireless fidelity (Wi-Fi) antenna, a worldwide interoperability for microwave access (Wimax) or an actor network theory+(Ant+) technique. However, in another embodiment of the present invention, the first transceiver unit 1026 transmits the modulation signal MS to the second transceiver unit 1026 in a wired manner.

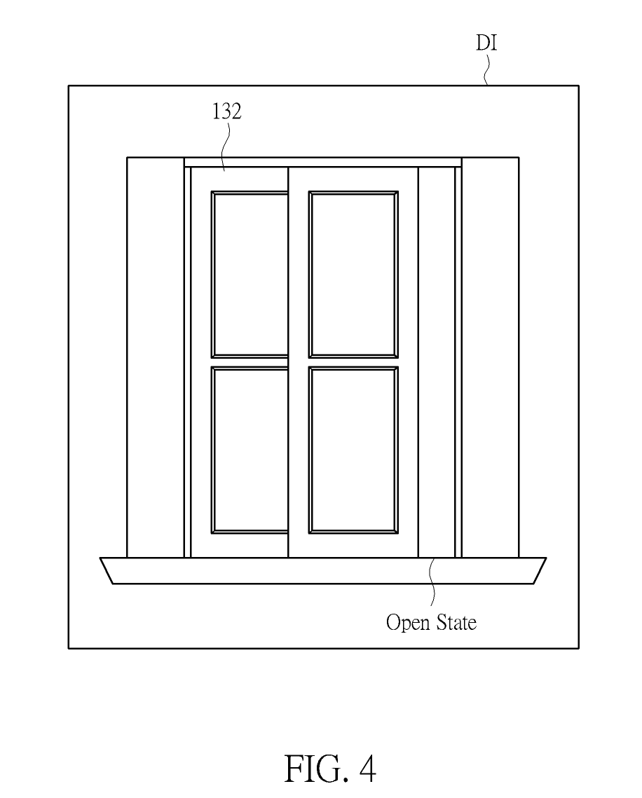

As shown in FIG. 2, the signal generation unit 1142 is used for generating the control signal CS in real-time or regularly, and then transmit the control signal CS to the image module 102 through the second transceiver unit 1144. Hence, the lens unit 1022 inside the image module 102 can capture the image 103 in real-time or regularly according to the control signal CS. When the second transceiver unit 1144 receives the modulation signal MS transmitted from the first transceiver unit 1026, the decoder 1146 is used for decoding the modulation signal MS to generate a decoded image DI corresponding to the image 103 and the identification code IDC of the image module 102. A decoding method of the decoder 1146 needs to correspond to a coding method of the encoder 1024, and the decoded image DI relates to a current state of the window 132. After the decoder 1146 generates the decoded image DI of the image 103 and the identification code IDC of the image module 102, the comparison unit 1148 can be used for comparing the decoded image DI and a reference image, and determine whether the decoded image DI matches the reference image. The reference image is stored in memories of the control module 114 (not shown in FIG. 2), and the reference image relates to a predetermined state of the window 132 (a closed state of the window 132 shown in FIG. 3). The comparison unit 1148 utilizes the signature method to capture a plurality of (such as 5) characteristics to describe features of the window 132. The present invention is not limited to the comparison unit 1148 using the signature method to capture the features of the window 132. That is, the comparison unit 1148 can utilize other existing techniques to describe the features of the window 132. After the comparison unit 1148 utilizes the signature method to determine the features of the window 132, the comparison unit 1148 can use a direct comparison method to compare the decoded image DI and the reference image. However, the present invention is not limited to the comparison unit 1148 using the direct comparison method to compare the decoded image DI and the reference image. That is, the comparison unit 1148 can utilize comparison methods provided by other existing techniques to compare the decoded image DI with the reference image. When the comparison unit 1148 determines that the decoded image DI does not match the reference image (e.g., the window 132 is opened in FIG. 4), the notification unit 150 generates and transmits an alarm signal AS to a portable device 116. The notification unit 1150 transmits the alarm signal AS and the identification code IDC of the image module 102 to the portable device 116 through a wireless local area network, a Zigbee standard, a Bluetooth, a wireless wide area network, a global system for mobile communications, a general packet radio service, a third generation technique, a wireless fidelity antenna, a worldwide interoperability for microwave access or an actor network theory+ technique. The portable device 116 can be a cell phone, a tablet, or a personal digital assistance. Hence, the user can be aware of whether the window 132 has an unusual state (e.g. the window 132 is damaged by an external force) according to the identification code IDC and the alarm signal AS of the image nodule 102.

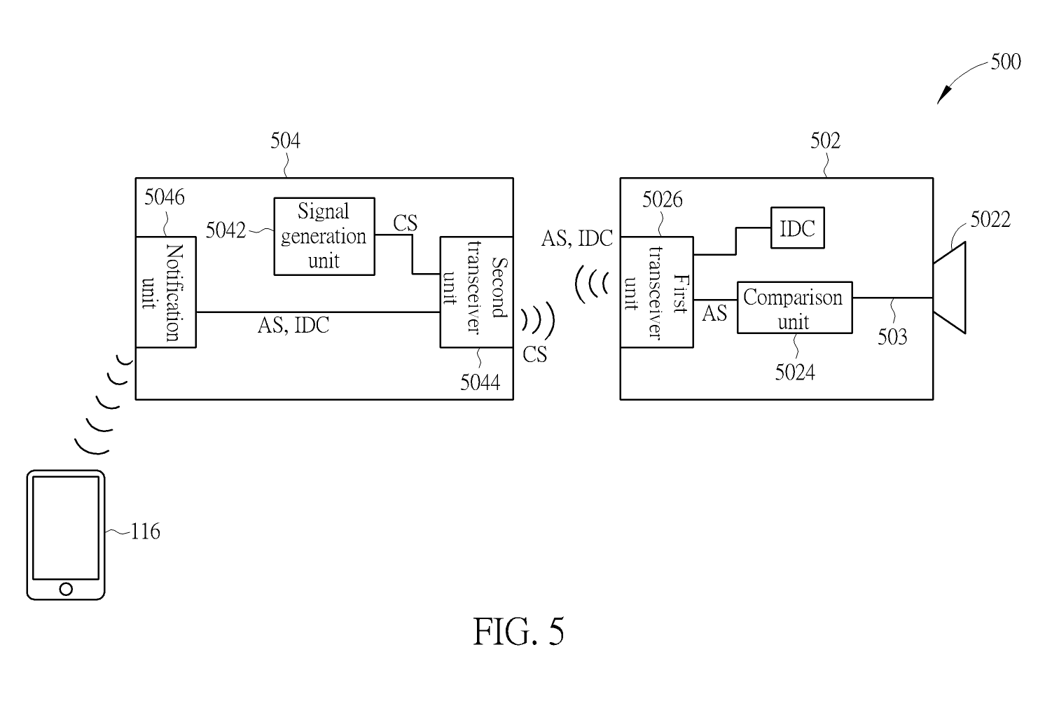

Please refer to FIG. 5, which is a diagram illustrating an addressable monitoring system 500 according to another embodiment of the present invention. As shown in FIG. 5, an image module 502 of the addressable monitoring system 500 includes a lens unit 5022, a comparison unit 5024, and a first transceiver unit 5026. A control module 504 of the addressable monitoring system 500 includes a signal generation unit 5042, a second transceiver unit 5044, and a notification unit 5046. The image module 502 has an identification code IDC. Hence, the difference between the addressable monitoring system 500 and the addressable monitoring system 100 is that the image module 502 has the comparison unit 5024 but does not have an encoder, and the control module 504 has the notification unit 5046 but does not have a decoder and a comparison unit. As shown in FIG. 5, the lens unit 5022 is used for capturing an image 503 according to a control signal CS. The comparison unit 5024 is used for comparing the image 503 with a reference image (the reference image is stored in memories of the control module 504 (not shown in FIG. 5)), and determine whether the image 503 matches the reference image. When the image 503 does not match the reference image, the comparison unit 5024 generates and transmits an alarm signal AS. The first transceiver unit 5026 is used for transmitting the alarm signal AS and the identification code IDC to the second transceiver unit 5044 of the control module 504. As shown in FIG. 5, the signal generation unit 5042 is used for generating the control signal CS in real-time or regularly, and transmitting the control signal CS to the image module 502 through the second transceiver unit 5044. After the second transceiver unit 5044 receives the alarm signal AS and the identification code IDC, the notification unit 5046 is used for transmitting the alarm signal AS and the identification code IDC to the portable device 116. Further, the present invention is not limited to the addressable monitoring system 500 only including the image module 502. That is, the addressable monitoring system 500 may include at least one image module. Moreover, rest operation principles of the addressable monitoring system 500 are the same as those of the addressable monitoring system 100, and will be omitted for brevity.

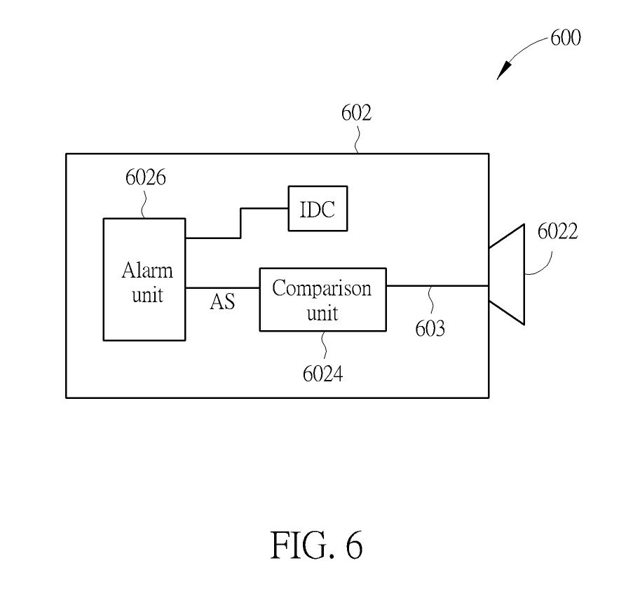

Please FIG. 6, which is a diagram illustrating an addressable monitoring system 600 according to yet another embodiment of the present invention. The addressable monitoring system 600 includes an image module 602, and the image module 602 includes an identification code IDC. As shown in FIG. 6, the image module 602 of the addressable includes a lens unit 6022, a comparison unit 6024, and an alarm unit 6026. Hence, the difference between the addressable monitoring system 600 and the addressable monitoring system 500 is that the image module 602 has the alarm unit 6026 but does not have a first transceiver unit. As shown in FIG. 6, the lens unit 6022 is used for capturing an image 603. The comparison unit 6024 is used for comparing the image 603 with a reference image (the reference image is stored in memories of the image module 602 (not shown in FIG. 6)), and determine whether the image 603 matches the reference image. When the image 603 does not match the reference image, the comparison unit 6024 generates and transmits an alarm signal AS. When the comparison unit 6024 generates and transmits the alarm signal AS, the alarm unit 6026 is used for generating flicker light, special sound, or a combination of flicker light and special sound to alarm the user. Moreover, rest operation principles of the addressable monitoring system 600 are the same as those of the addressable monitoring system 500, and will be omitted for brevity.

In view of above, the present invention provides an addressable monitoring system. The addressable monitoring system utilizes each image module to capture an image including at least one monitored object, and then compares the image including at least one monitored object with a reference image to determine whether the at least one monitored object is unusual. Hence, compared with the prior art, the present invention includes the following advantages: first, since each image module has a corresponding identification code, the user can be quickly aware of which monitored object of the at least one monitored object is unusual; second, since each image module of the addressable monitoring system is coupled to the same power line, and unitizes the same power line to transmit a signal including an identification code of each image module of the addressable monitoring system, the present invention has simple arrangement and will not affect indoor decoration; third, the user can be aware of which monitored object of the at least one monitored object is unusual in real-time through the portable device; fourth, since each of the image modules of the addressable monitoring system is capable of monitoring one or multiple objects according to the user's requirement, the present invention is more flexible to be designed; and fifth, since the present invention determines whether a monitored object of the at least one monitored object is unusual through image comparison, the at least one monitored object does not need to be airtight to keep the indoor environment to be well ventilated.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An addressable monitoring system, comprising:
at least one image module, wherein each image module of the at least one image module has an identification code, and the image module comprises:
a lens unit, for capturing an image according to a control signal;
an encoder, for modulating the identification code into the image to generate a modulation signal; and
a first transceiver unit, for transmitting the modulation signal; and
a control module, comprising:
a signal generation unit, for generating the control signal;
a second transceiver unit, for receiving the modulation signal;
a decoder, for decoding the modulation signal to generate a decoded image corresponding to the image and the identification code; and
a comparison unit, for comparing the decoded image with a reference image, and determining whether the decoded image matches the reference image.

2. The addressable monitoring system of claim 1, wherein the signal generation unit generates the control signal in real-time or regularly.

3. The addressable monitoring system of claim 1, wherein the first transceiver unit transmits the modulation signal in a wired manner.

4. The addressable monitoring system of claim 1, wherein the first transceiver unit transmits the modulation signal through a wireless local area network (WLAN), a Zigbee (IEE 802.15.4) standard, a Bluetooth, a wireless wide area network (WLAN), a global system for mobile communications (GSM), a general packet radio service (GPRS), a third generation (3G) technique, a wireless fidelity (Wi-Fi) antenna, a worldwide interoperability for microwave access (Wimax) or an actor network theory+ (Ant+) technique.

5. The addressable monitoring system of claim 1, wherein the image comprises a current state of at least one object.

6. The addressable monitoring system of claim 1, wherein the identification code is burned to the image module before or after the image module is shipped.

7. The addressable monitoring system of claim 1, wherein the control module further comprises:
a notification unit, for generating and transmitting an alarm signal to a portable device when the comparison unit determines that the decoded image does not match the reference image.

8. The addressable monitoring system of claim 7, wherein the notification unit transmits the alarm signal through a wireless local area network, a Zigbee standard, a Bluetooth, a wireless wide area network, a global system for mobile communications, a general packet radio service, a third generation technique, a wireless fidelity antenna, a worldwide interoperability for microwave access or an actor network theory+ technique.

9. The addressable monitoring system of claim 7, wherein the portable device is a cell phone, a tablet or a personal digital assistance (PDA).

10. An addressable monitoring system, comprising:
at least one image module, wherein each image module of the at least one image module has an identification code, and the image module comprises:
a lens unit, for capturing an image according to a control signal;
a comparison unit, for comparing the image with a reference image, and determining whether the image matches the reference image, wherein when the image does not match the reference image, the comparison unit generates and transmits an alarm signal; and
a first transceiver unit, for transmitting the alarm signal and the identification code; and
a control module, comprising:
a signal generation unit, for generating the control signal;
a second transceiver unit, for receiving the alarm signal and the identification code; and
a notification unit, for transmitting the alarm signal and the identification code to a portable device.

11. The addressable monitoring system of claim 10, wherein the signal generation unit generates the control signal in real-time or regularly.

12. The addressable monitoring system of claim 10, wherein the first transceiver unit transmits the modulation signal in a wired manner.

13. The addressable monitoring system of claim 10, wherein the first transceiver unit transmits the modulation signal through a wireless local area network, a Zigbee standard, a Bluetooth, a wireless wide area network, a global system for mobile communications, a general packet radio service, a third generation technique, a wireless fidelity antenna, a worldwide interoperability for microwave access or an actor network theory+ technique.

14. The addressable monitoring system of claim 10, wherein the notification unit transmits the alarm signal through a wireless local area network, a Zigbee standard, a Bluetooth, a wireless wide area network, a global system for mobile communications, a general packet radio service, a third generation technique, a wireless fidelity antenna, a worldwide interoperability for microwave access or an actor network theory+ technique.

15. The addressable monitoring system of claim 10, wherein the portable device is a cell phone, a tablet or a personal digital assistance.

16. The addressable monitoring system of claim 10, wherein the image comprises a current state of at least one object.

17. The addressable monitoring system of claim 10, wherein the identification code is burned to the image module before or after the image module is shipped.

18. An addressable monitoring system, comprising:
at least one image module, wherein each image module of the at least one image module has an identification code, and the image module comprises:
a lens unit, for capturing an image;
a comparison unit, for comparing the image with a reference image, and determining whether the image matches the reference image, wherein when the image does not match the reference image, the comparison unit generates and transmits an alarm signal; and
an alarm unit, for generating a combination of flicker light and special sound according to the alarm signal.

19. The addressable monitoring system of claim 18, wherein the image comprises a current state of at least one object.

20. The addressable monitoring system of claim 18, wherein the identification code is burned to the image module before or after the image module is shipped.
